(19) United States
(12) Patent Application Publication
(10) Pub. No.: US 2023/0186583 A1
(43) Pub. Date: Jun. 15, 2023

(54) METHOD AND DEVICE FOR PROCESSING VIRTUAL DIGITAL HUMAN, AND MODEL TRAINING METHOD AND DEVICE

(71) Applicant: BEIJING BAIDU NETCOM SCIENCE TECHNOLOGY CO., LTD., Beijing (CN)

(72) Inventor: Ziyuan GUO, Beijing (CN)

(21) Appl. No.: 18/106,006

(22) Filed: Feb. 6, 2023

(30) Foreign Application Priority Data
May 19, 2022 (CN) 202210547459.8

(51) Int. Cl. G06T 19/20; G06V 10/82; G06V 40/20

(52) U.S. Cl. CPC G06T 19/20; G06V 10/82; G06V 40/23

(57) ABSTRACT

A method for processing a virtual digital human includes: obtaining a key point image sequence of a reference role; determining key point data of the virtual digital human corresponding to key point data in the key point image sequence based on the key point data in the key point image sequence when the virtual digital human is projected into a two-dimensional space; obtaining a bone rotation coefficient sequence of the virtual digital human based on the key point data of the virtual digital human; and driving the virtual digital human to perform corresponding actions based on the bone rotation coefficient sequence.

### CROSS-REFERENCE TO RELATED APPLICATION

This application is based upon and claims priority to Chinese Patent Application No. 2022105474598, filed on May 19, 2022, the entire content of which is incorporated herein by reference.

### TECHNICAL FIELD

The disclosure relates to the field of image processing, especially the field of artificial intelligence such as augmented reality technology and deep learning technology, in particular to a method for processing a virtual digital human, a method for training a virtual digital human creation model, an electronic device, and a storage medium.

### BACKGROUND

The real three-dimensional (3D) digital human driving has been a hot research topic in the academia and has a wide range of industrial applications, for example, the most common applications include virtual anchors, virtual service personnel, virtual assistants, virtual classrooms, virtual idols, and other interactive games and entertainments.

In the related art, a motion capture shed is built by commercial software for optical motion capture. Alternatively, wearable sensor devices are used to capture human motions using inertial motion capture software to drive digital human limb motions in real time.

However, solutions based on optical or inertial motion capture rely on expensive acquisition devices, highly-equipped computer hardware, and complex and demanding solving processes, which makes it difficult to have universal applicability.

### SUMMARY

According to the first aspect of the disclosure, a method for processing a virtual digital human is provided. The method includes: obtaining a key point image sequence of a reference role; determining key point data of the virtual digital human corresponding to key point data in the key point image sequence based on the key point data in the key point image sequence when the virtual digital human is projected into a two-dimensional space; obtaining a bone rotation coefficient sequence of the virtual digital human based on the key point data of the virtual digital human; and driving the virtual digital human to perform corresponding actions based on the bone rotation coefficient sequence.

According to the second aspect of the disclosure, a method for training a virtual digital human creation model is provided. The virtual digital human creation model includes an action encoding sub-model and an action prior sub-model. The method includes: obtaining motion capture data and analyzing the motion capture data, to obtain a first bone rotation coefficient of the virtual digital human, and training a variational auto-encoder based on the first bone rotation coefficient, in which the variational auto-encoder includes an encoder, an intermediate encoding vector, and a decoder; determining the intermediate encoding vector and the decoder of the trained variational auto-encoder as the action prior sub-model; training the action prior sub-model based on a key point image sequence of a reference role sample, and determining model parameters of the action prior sub-model until the trained action prior sub-model satisfies preset conditions; obtaining training data, in which the training data includes key point data of the virtual digital human and a second bone rotation coefficient; and training the virtual digital human creation model based on the key point data of the virtual digital human and the second bone rotation coefficient until training termination conditions are satisfied.

According to the third aspect of the disclosure, an electronic device is provided. The electronic device includes: at least one processor; and a memory communicatively coupled to the at least one processor; in which the memory stores instructions executable by the at least one processor, and when the instructions are executed by the at least one processor, the at least one processor is caused to implement the method of the first aspect and/or the method of the second aspect.

According to the fourth aspect of the disclosure, a non-transitory computer readable storage medium having computer instructions stored thereon is provided. The computer instructions are configured to cause a computer to implement the method of the first aspect and/or the method of the second aspect.

According to the fifth aspect of the disclosure, a computer program product including computer programs is provided. When the computer programs are executed by a processor, the method of the first aspect and/or the method of the second aspect is implemented.

It should be understood that the content described in this section is not intended to identify key or important features of the embodiments of the disclosure, nor is it intended to limit the scope of the disclosure. Additional features of the disclosure will be easily understood based on the following description.

### BRIEF DESCRIPTION OF THE DRAWINGS

The drawings are used to better understand the solutions and do not constitute a limitation to the disclosure, in which:

FIG. 1A is a flowchart of a method for processing a virtual digital human according to some embodiments of the disclosure.

FIG. 1B is an example diagram of key point data in a key point image sequence according to some embodiments of the disclosure.

FIG. 2 is a flowchart of a method for visually editing a key point image according to some embodiments of the disclosure.

FIG. 3 is a flowchart of another method for processing a virtual digital human according to some embodiments of the disclosure.

FIG. 4 is a flowchart of yet another method for processing a virtual digital human according to some embodiments of the disclosure.

FIG. 5 is a flowchart of a method for processing a virtual digital human according to some embodiments of the disclosure.

FIG. 6 is a flowchart of a method for training a virtual digital human creation model according to some embodiments of the disclosure.

FIG. 7 is a schematic diagram of a variational auto-encoder according to some embodiments of the disclosure.

FIG. 8 is a schematic diagram of an apparatus for processing a virtual digital human according to some embodiments of the disclosure.

FIG. 9 is a schematic diagram of another apparatus for processing a virtual digital human according to some embodiments of the disclosure.

FIG. 10 is a schematic diagram of yet another apparatus for processing a virtual digital human according to some embodiments of the disclosure.

FIG. 11 is a schematic diagram of another apparatus for processing a virtual digital human according to some embodiments of the disclosure.

FIG. 12 is a schematic diagram of an apparatus for training a virtual digital human creation model according to some embodiments of the disclosure.

FIG. 13 is a schematic diagram of another apparatus for training a virtual digital human creation model according to some embodiments of the disclosure.

FIG. 14 is a block diagram of an electronic device for implementing a method for processing a virtual digital human or a training method according to some embodiments of the disclosure.

### DETAILED DESCRIPTION

The following describes embodiments of the disclosure with reference to the accompanying drawings, which includes various details of the embodiments of the disclosure to facilitate understanding and shall be considered merely exemplary. Therefore, those of ordinary skill in the art should recognize that various changes and modifications can be made to the embodiments described herein without departing from the scope and spirit of the disclosure. For clarity and conciseness, descriptions of well-known functions and structures are omitted in the following description.

A method for processing a virtual digital human, a method for training a virtual digital human creation model, an apparatus for processing a virtual digital human, and an apparatus for training a virtual digital human creation model are described below with reference to the accompanying drawings.

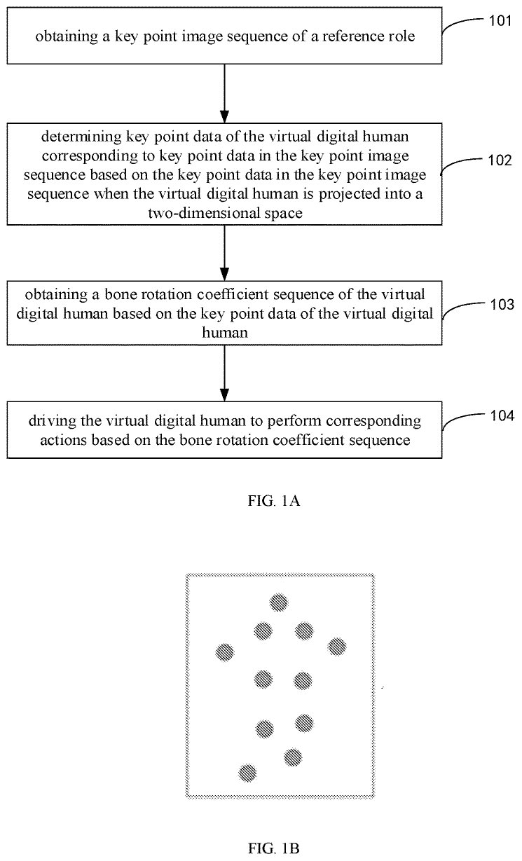

FIG. 1A is a flowchart of a method for processing a virtual digital human according to some embodiments of the disclosure. It is noted that the method for processing a virtual digital human according to some embodiments may be applied to an apparatus for processing a virtual digital human according to some embodiments. The apparatus may be configured on an electronic device. As shown in FIG. 1A, the method for processing a virtual digital human may include, but is not limited to, the following steps.

At step 101, a key point image sequence of a reference role is obtained.

In embodiments of the disclosure, the key point image sequence includes at least one key point image. It is understood that the key point image may be a two-dimensional image. The key point image may be understood to be a key point data image for limbs of the reference role. For example, as shown in FIG. 1B, it is a key point image in the key point image sequence of the reference role, and each image in the sequence has the key point data for limbs of the reference role. Optionally, the key point image sequence may also be referred to as a key point animation sequence.

In embodiments of the disclosure, the key point image sequence may be pre-given. Alternatively, the key point image sequence of the reference role may also be obtained by performing a two-dimensional key point data detection for limbs on a reference role video captured in real time by image collection devices (e.g., cameras).

At step 102, key point data of the virtual digital human corresponding to key point data in the key point image sequence is determined based on the key point data in the key point image sequence when the virtual digital human is projected into a two-dimensional space.

Optionally, the key point image sequence includes a T-shape pose image. For example, the T-shape pose image may be the first image in the key point image sequence. The T-shape pose image is a human pose with arms horizontally extended, which can clearly express a body structure ratio of the reference role in the key point data in the image. Since there may be a difference between the body structure ratio of the reference role and a body joint ratio of the virtual digital human, the body structure ratio of the reference role can be used to update the key point data of the virtual digital human, i.e., to update the key point data of the limbs of the virtual digital human, to ensure that the body joint ratio of the virtual digital human is consistent with the body structure ratio of the reference role.

It is understood that since the key point data of the virtual digital human is obtained when the key point data in each key point image of the reference role is projected, a number of key point data images of the virtual digital human should be the same as a number of key point images of the reference role, and a total number of key point data of the virtual digital human should be the same as a total number of key point data of the reference role. For example, the key point image sequence of the reference role includes two key point images, i.e., the first key point image and the second key point image. The key point data of the virtual digital human corresponding to the key point data in the first key point image is determined based on the key point data in the first key point image when the virtual digital human is projected into the two-dimensional space. The key point data of the virtual digital human corresponding to the key point data in the second key point image is determined based on the key point data in the second key point image when the virtual digital human is projected into the two-dimensional space. A combination of the key point data of the virtual digital human obtained based on these two key point images is determined as final key point data of the virtual digital human. The combination of the key point data of the virtual digital human may be a combination of key point data according to the order of key point images in the key point image sequence. For example, the combination of the key point data of the virtual digital human is {the key point data of the virtual digital human corresponding to the key point data in the first key point image, and the key point data of the virtual digital human corresponding to the key point data in the second key point image}.

At step 103, a bone rotation coefficient sequence of the virtual digital human is obtained based on the key point data of the virtual digital human.

In a possible implementation, a mapping relation between the key point data of the virtual digital human and the bone rotation coefficient of the virtual digital human is determined in advance. In this way, the bone rotation coefficient having the mapping relation with the key point data of the virtual digital human is determined based on the mapping relation and the key point data of the virtual digital human determined at step 102. Since the key point data of the virtual digital human may be a combination of key point data, when the bone rotation coefficients are determined using the above mapping relation, the bone rotation coefficient sequence of the virtual digital human is obtained, i.e., a series of bone rotation coefficients is obtained.

In another possible implementation, the bone rotation coefficient sequence of the virtual digital human is obtained using a model. For example, the virtual digital human creation model is pre-trained, such that the virtual digital human creation model has learned the mapping relation between the key point data and the bone rotation coefficients. In this way, the virtual digital human creation model can be used to predict the key point data of the virtual digital human, to obtain the bone rotation coefficient sequence of the virtual digital human output by the virtual digital human creation model.

At step 104, the virtual digital human is driven to perform corresponding actions based on the bone rotation coefficient sequence.

In an implementation, the virtual digital human is driven to perform the corresponding actions based on the bone rotation coefficient sequence by using a virtual digital human driving module.

For example, if the reference role performs a hand waving action, a key point image sequence of the hand waving action of the reference role is obtained. The key point data of the virtual digital human corresponding to the key point data of the reference role is determined based on the key point data in the key point image sequence when the virtual digital human is projected into the two-dimensional space. The bone rotation coefficient sequence of the virtual digital human is obtained based on the key point data of the virtual digital human. The virtual digital human driving module can be used to drive the virtual digital human to perform the corresponding waving action based on the bone rotation coefficient sequence.

Optionally, the method for processing a virtual digital human of the disclosure can be applied to an online real-time scene, that is, the method for processing a virtual digital human of the disclosure can be used to drive the virtual digital human to perform the corresponding action in real time using key points of the reference role. For example, the method for processing a virtual digital human of the disclosure can be applied to a live broadcast scenario where the virtual digital human is a virtual anchor, the anchor turns on cameras of a live broadcast room, and the two-dimensional key point data detection of limbs is performed frame (or key frame) by frame for a live video stream of the anchor captured by the cameras, to obtain the key point image sequence of this anchor. The key point data of the virtual anchor corresponding to the key point data of the anchor is determined based on the key point data in the key point image sequence when the virtual anchor is projected into the two-dimensional space. The bone rotation coefficient sequence of the virtual anchor is obtained based on the key point data of the virtual anchor. The virtual anchor is driven to perform the corresponding waving action based on the bone rotation coefficient sequence by using the driving module on a playback interface of the live broadcast room.

According to the method for processing a virtual digital human of the disclosure, the key point image sequence of the reference role can be used to drive the virtual digital human to do synchronized gesture motions in real time. Compared with the related art, this disclosure can provide a low-cost and friendly driving solution for users, which greatly reduces the prophase equipment investment costs.

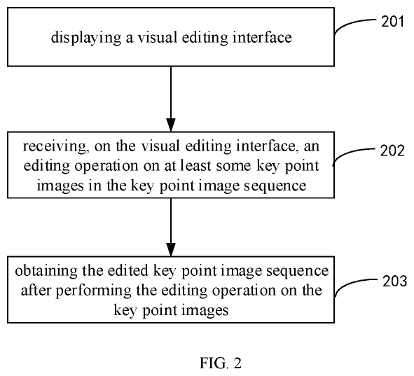

In order to reduce the cost of editing poses of the virtual digital human, the disclosure may provide a visual editing function for key point images. Optionally, in some embodiments of the disclosure, as shown in FIG. 2, the visual editing method for the key point images may include, but is not limited to, the following steps.

At step 201, a visual editing interface is displayed.

In an implementation, the visual editing interface for the key point images is provided. When an editing object clicks on the interface, the visual editing interface can be displayed, so that the editing object can perform editing operations on the key point images in the key point image sequence on the visual editing interface. The editing object can perform the editing operations on one or more key point images in the key point image sequence on the visual editing interface.

At step 202, on the visual editing interface, an editing operation on at least some key point images in the key point image sequence is received.

At step 203, the edited key point image sequence is obtained after performing the editing operation on the key point images. Therefore, the key point image sequence after the visual editing can be processed using the method for processing a virtual digital human in the disclosure, to generate a corresponding virtual digital human action sequence.

It can be seen that the disclosure can provide the visual editing function for the key point images, so that the visual editing operation is performed on the key point images of the reference role. The key point image sequence after the visual editing can be used to synchronously update the pose of the virtual digital human, which avoids directly editing bones of the virtual digital human, and greatly reduces the editing cost of the poses of the virtual digital human.

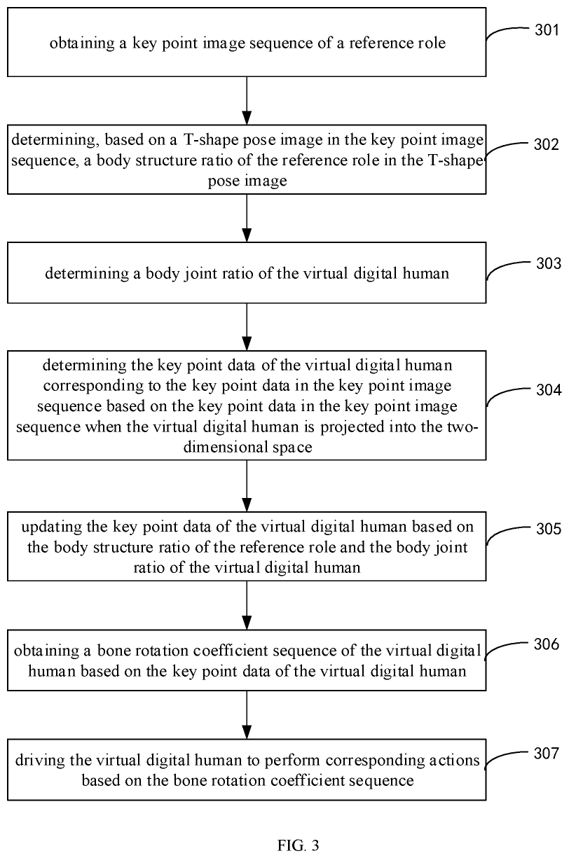

It is to be noted that since there may be a difference between the body structure ratio of the reference role and the body joint ratio of the virtual digital human, the key point data of the virtual digital human is updated based on the body structure ratio of the reference role, i.e., the key point data of the limbs of the virtual digital human is updated, to ensure that the body structure ratio of the reference role is consistent with the body joint ratio of the virtual digital human. Optionally, in some embodiments of the disclosure, as shown in FIG. 3, the method for processing a virtual digital human may include, but is not limited to, the following steps.

At step 301, a key point image sequence of a reference role is obtained.

In embodiments of the disclosure, step 301 may be implemented in any implementation of the embodiments of the disclosure, which is not limited in the embodiments of the disclosure and will not be repeated.

At step 302, based on a T-shape pose image in the key point image sequence, a body structure ratio of the reference role in the T-shape pose image is determined.

Optionally, the key point image sequence includes the T-shape pose image. For example, the T-shape pose image may be the first image in the key point image sequence. The T-shape pose image is a human pose with arms horizontally extended, which can clearly express the body structure ratio of the reference role in the key point data of the image.

At step 303, a body joint ratio of the virtual digital human is determined.

In an implementation, the body joint ratio of the virtual digital human can be pre-given.

At step 304, the key point data of the virtual digital human corresponding to the key point data in the key point image sequence is determined based on the key point data in the key point image sequence when the virtual digital human is projected into the two-dimensional space.

It is understood that since the key point data of the virtual digital human is obtained when the key point data in each key point image of the reference role is projected, the number of key point data images of the virtual digital human should be the same as the number of key point data images of the reference role, and the total number of the key point data of the virtual digital human should also be the same as the total number of the key point data of the reference role. For example, the key point image sequence of the reference role includes two key point images, i.e., the first key point image and the second key point image. The key point data of the virtual digital human corresponding to the key point data in the first key point image is determined based on the key point data in the first key point image when the virtual digital human is projected into the two-dimensional space. The key point data of the virtual digital human corresponding to the key point data in the second key point image is determined based on the key point data in the second key point image when the virtual digital human is projected into the two-dimensional space. The combination of the key point data of the virtual digital human obtained based on these two key point images is determined as the final key point data of the virtual digital human. The combination of the key point data of the virtual digital human may be a combination of key point data according to the order of key point images in the key point image sequence. For example, the combination of the key point data of the virtual digital human is {the key point data of the virtual digital human corresponding to the key point data in the first key point image, and the key point data of the virtual digital human corresponding to the key point data in the second key point image}.

At step 305, the key point data of the virtual digital human is updated based on the body structure ratio of the reference role and the body joint ratio of the virtual digital human.

In an implementation, updating the key point data of the virtual digital human includes: updating respective vector length ratios of connection lines among key points in the key point data of the virtual digital human. That is, the respective vector length ratios of connection lines among the key points in the key point data of the virtual digital human is updated based on the body structure ratio of the reference role and the body joint ratio of the virtual digital human, and vector angles of connection lines in the key point data of the virtual digital human remain unchanged.

At step 306, a bone rotation coefficient sequence of the virtual digital human is obtained based on the key point data of the virtual digital human.

In embodiments of the disclosure, step 306 may be implemented in any implementation of the embodiments of the disclosure, which is not limited in the embodiments of the disclosure and will not be repeated.

At step 307, the virtual digital human is driven to perform corresponding actions based on the bone rotation coefficient sequence.

In embodiments of the disclosure, step 307 may be implemented in any implementation of the embodiments of the disclosure, which is not limited in the embodiments of the disclosure and will not be repeated.

According to the method for processing a virtual digital human of the embodiments, the key point data of the virtual digital human is updated based on the body structure ratio of the reference role, i.e., the key point data of the limbs of the virtual digital human is updated, to ensure that the body joint ratio of the virtual digital human is consistent with the body structure ratio of the reference role.

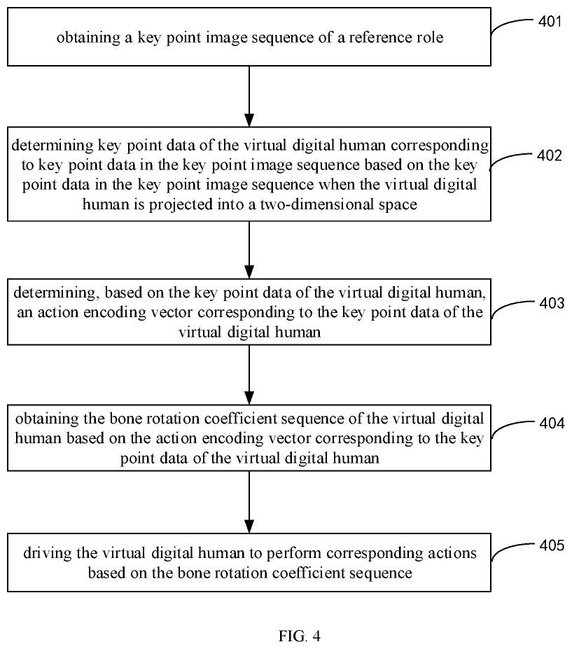

In an implementation, the action encoding vector may be used to determine the bone rotation coefficients of the virtual digital human based on the key point data of the virtual digital human. Optionally, in some embodiments of the disclosure, as shown in FIG. 4, the method for processing a virtual digital human may include, but is not limited to, the following steps.

At step 401, a key point image sequence of a reference role is obtained.

In embodiments of the disclosure, step 401 may be implemented in any implementation of the embodiments of the disclosure, which is not limited in the embodiments of the disclosure and will not be repeated.

At step 402, key point data of the virtual digital human corresponding to key point data in the key point image sequence is determined based on the key point data in the key point image sequence when the virtual digital human is projected into a two-dimensional space.

In embodiments of the disclosure, step 402 may be implemented in any implementation of the embodiments of the disclosure, which is not limited in the embodiments of the disclosure and will not be repeated.

At step 403, based on the key point data of the virtual digital human, an action encoding vector corresponding to the key point data of the virtual digital human is determined.

In an implementation, the key point data of the virtual digital human is input into a preset virtual digital human creation model, in which the virtual digital human creation model has learned to obtain a mapping relation between the key point data and the bone rotation coefficient sequence, and the virtual digital human creation model includes an action encoding sub-model and an action prior sub-model. The action encoding vector corresponding to the key point data of the virtual digital human, output by the action encoding sub-model, is obtained.

For example, the virtual digital human creation model can be pre-trained, such that the virtual digital human creation model has learned to obtain the mapping relation between the key point data and the bone rotation coefficients. The virtual digital human creation model includes the action encoding sub-model and the action prior sub-model. The action encoding sub-model includes an action encoding vector module that learns a prior distribution of human actions. For example, the length of the action encoding vector output by the action encoding vector module can be 32, i.e., each action can be represented by a vector with a length of 32. The implementation of training this action encoding vector module can be described in subsequent embodiments and will not be repeated herein.

At step 404, the bone rotation coefficient sequence of the virtual digital human is obtained based on the action encoding vector corresponding to the key point data of the virtual digital human

In an implementation, the action encoding vector corresponding to the key point data of the virtual digital human is input into the action prior sub-model, and the bone rotation coefficient sequence of the virtual digital human is obtained. The implementation of training this action prior sub-model can be found in the subsequent embodiments and will not be repeated herein.

At step 405, the virtual digital human is driven to perform corresponding actions based on the bone rotation coefficient sequence.

In embodiments of the disclosure, step 405 may be implemented in any implementation of the embodiments of the disclosure, which is not limited in the embodiments of the disclosure and will not be repeated.

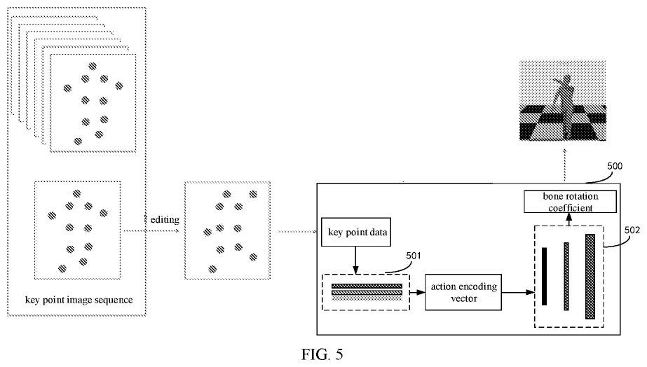

For example, as shown in FIG. 5, when the key point image sequence of the reference role sample is obtained, the visual editing interface is displayed, and the editing operation on at least some key point images in the key point image sequence is received on the visual editing interface, and the edited key point image sequence is obtained after performing the editing operation on the key point images. Based on the key point data in the edited key point image sequence, the key point data of the virtual digital human corresponding to the key point data when the virtual digital human is projected into the two-dimensional space is determined, and the key point data of the virtual digital human is input to the action encoding sub-model 501 in the virtual digital human creation model 500, to obtain the action encoding vector corresponding to the key point data of the virtual digital human. The action encoding vector is input to the action prior sub-model 502, to obtain the bone rotation coefficient sequence of the virtual digital human.

According to the method for processing a virtual digital human of the disclosure, the action encoding vector is used to determine the bone rotation coefficients of the virtual digital human based on the key point data of the virtual digital human, in which the length of the action encoding vector is 32, i.e., each action can be represented by a vector with a length of 32. The action encoding vector with a length of 32 is used to determine the corresponding bone rotation coefficient sequence of the virtual digital human, so that the generation of the bone rotation coefficients of the virtual digital human can be achieved using simple models.

In order to implement the above embodiments, the disclosure provides a method for training a virtual digital human creation model.

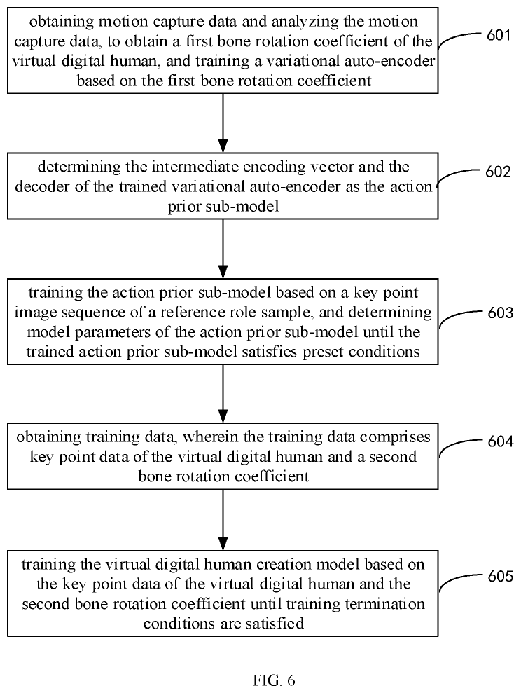

FIG. 6 is a flowchart of a method for training a virtual digital human creation model according to some embodiments of the disclosure. It is noted that the method for training a virtual digital human creation model according to some embodiments may be applied to an apparatus for training a virtual digital human creation model according to some embodiments. The apparatus may be configured in an electronic device.

It is further noted that the virtual digital human creation module of the disclosure may include an action encoding sub-model and an action prior sub-model. As shown in FIG. 6, the method for training a virtual digital human creation model may include, but is not limited to, the following steps.

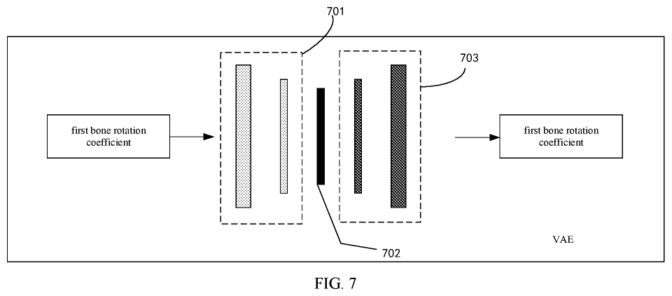

At step 601, motion capture data is obtained and analyzed, to obtain a first bone rotation coefficient of the virtual digital human, and a variational auto-encoder is trained based on the first bone rotation coefficient. As shown in FIG. 7, the Variational Auto-Encoder (VAE) includes an encoder 701, an intermediate encoding vector 702, and a decoder 703.

In an implementation, the motion capture data may be existing motion capture data. For example, the motion capture data in the related art can be obtained. That is, the disclosure can directly use the motion capture data in the related art, instead of laying out devices for capturing the motion capture data.

In some embodiments of the disclosure, the motion capture data is analyzed to obtain the first bone rotation coefficient of the virtual digital human. As shown in FIG. 7, the first bone rotation coefficient is used as the inputs of the VAE and also as the output result supervised training of the decoder in this VAE. The intermediate encoding vector 702 of the VAE may have a length of 32, i.e., each action may be represented by a vector with a length of 32. When training a large amount of motion capture data, the intermediate encoding vector 702 of the VAE can learn the prior distribution of human actions. The intermediate encoding vector 702 of the VAE and the decoder 703 are used as the action prior sub-model, i.e., the intermediate encoding vector 702 is used to generate the bone rotation coefficient sequence of the virtual digital human based on the decoder 703 by means of sampling.

At step 602, the intermediate encoding vector and the decoder of the trained VAE are determined as the action prior sub-model.

At step 603, the action prior sub-model is trained based on a key point image sequence of a reference role sample, and model parameters of the action prior sub-model are determined until the trained action prior sub-model satisfies preset conditions.

In an implementation, the key point data of the virtual digital human is obtained based on the key point image sequence and the body joint ratio of the virtual digital human. The key point data of the virtual digital human is input into the action prior sub-model, and a first bone rotation coefficient prediction value output by the action prior sub-model is obtained. The first bone rotation coefficient prediction value is projected into a two-dimensional space, to obtain a key point data prediction value of the virtual digital human. A first loss value is generated based on the key point data of the virtual digital human and the key point data prediction value. The action prior sub-model is trained based on the first loss value. The loss function for calculating the first loss value can be a crossover loss function or other loss functions, which is not limited in the disclosure.

In a possible implementation, a body structure ratio of the reference role in a T-shape pose image is determined based on the T-shape pose image in the key point image sequence. The body joint ratio of the virtual digital human is determined. The key point data of the virtual digital human corresponding to the key point data in the key point image sequence is determined based on the key point data in the key point image sequence when the virtual digital human is projected into the two-dimensional space. The key point data of the virtual digital human is updated based on the body structure ratio of the reference role and the body joint ratio of the virtual digital human. The updated content is respective vector length ratios of connection lines among key points in the key point data of the virtual digital human. In addition, updating the key point data of the virtual digital human is implemented in any implementation of the embodiments of the disclosure, which is not limited in the embodiments of the disclosure and will not be repeated.

At step 604, training data is obtained, in which the training data includes key point data of the virtual digital human and a second bone rotation coefficient.

In embodiments of the disclosure, the second bone rotation coefficient may be the same as the first bone rotation coefficient. Alternatively, the second bone rotation coefficient may be different from the first bone rotation coefficient.

In embodiments of the disclosure, the key point data in the training data may correspond to the second bone rotation coefficients. Alternatively, the key point data in the training data may not correspond to the second bone rotation coefficients.

At step 605, the virtual digital human creation model is trained based on the key point data of the virtual digital human and the second bone rotation coefficient until training termination conditions are satisfied.

In an implementation, the virtual digital human creation model may be a real-time inference network with a Long Short-Term Memory (LSTM) as the main architecture. For example, the virtual digital human creation model may include an action encoding sub-model and an action prior sub-model constructed based on the LSTM. It is understood that when the virtual digital human creation model is trained at step 605, the model parameters of the action prior sub-model in the virtual digital human creation model are determined and are no longer involved in training and learning.

In a possible implementation, the key point data of the virtual digital human is input into the action encoding sub-model, and the action encoding vector output by the action encoding sub-model is obtained. The action encoding vector is input to the action prior sub-model, and the second bone rotation coefficient prediction value output by the action prior sub-model is obtained. The second loss value is generated based on the second bone rotation coefficient prediction value and the second bone rotation coefficient. The model parameters of the action encoding sub-model are adjusted based on the second loss value.

That is, when training the virtual digital human creation model, the model parameters of the action encoding sub-model in the virtual digital human creation model need to be adjusted, so that the action encoding sub-model learns the mapping relation between the key point data of the virtual digital human and the action encoding vectors. The loss function for calculating the second loss value may be a crossover loss function or other loss functions, which is not limited in the disclosure.

In some embodiments of the disclosure, the visual editing interface is displayed. The editing operation on at least some key point images in the key point image sequence is received on the visual editing interface. The edited key point image sequence is obtained after performing the editing operation on the key point images. Therefore, more key point images of the pose can be obtained through the visual editing interface to enrich the training data.

According to the method for training a virtual digital human creation model of the disclosure, the action prior sub-model is generated based on the existing motion capture data, and the action prior sub-model is trained based on the key point image sequence of the reference role sample until the trained action prior sub-model satisfies the preset conditions. The model parameters of the action prior sub-model are determined. The action encoding sub-model in the virtual digital human creation model is trained based on the key point data and the bone rotation coefficients of the virtual digital human until the training termination conditions are satisfied. When the method is applied to online applications, the key point image sequence of the reference role is used to drive the virtual digital human to do synchronized gesture motions in real time. Compared with the related art, the disclosure provides a low-cost and user-friendly driving solution for users, which greatly reduces the initial equipment investment costs.

In order to implement the above embodiments, the disclosure also provides an apparatus for processing a virtual digital human.

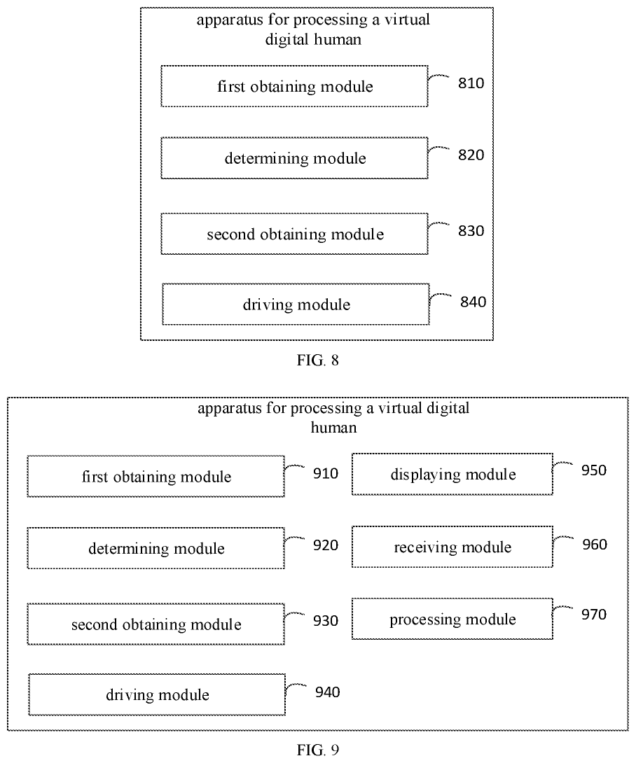

FIG. 8 is a schematic diagram of an apparatus for processing a virtual digital human according to some embodiments of the disclosure. As shown in FIG. 8, the apparatus includes: a first obtaining module 810, a determining module 820, a second obtaining module 830, and a driving module 840.

The first obtaining module 810 is configured to obtain a key point image sequence of a reference role.

The determining module 820 is configured to determine key point data of the virtual digital human corresponding to key point data in the key point image sequence based on the key point data in the key point image sequence when the virtual digital human is projected into a two-dimensional space.

The second obtaining module 830 is configured to obtain a bone rotation coefficient sequence of the virtual digital human based on the key point data of the virtual digital human.

The driving module 840 is configured to drive the virtual digital human to perform corresponding actions based on the bone rotation coefficient sequence.

With the apparatus for processing a virtual digital human according to the embodiment of the disclosure, the key point image sequence of the reference role is used to drive the virtual digital human to do the synchronized gesture motions in real time. Compared with the related art, this disclosure can provide a low-cost and friendly driving solution for users, which greatly reduces the prophase equipment investment costs.

In order to reduce the cost of editing poses of the virtual digital human, the disclosure may provide a visual editing function for key point images. Optionally, in some embodiments of the disclosure, as shown in FIG. 9, the apparatus for processing a virtual digital human may also include: a displaying module 950, a receiving module 960, and a processing module 970.

The displaying module 950 is configured to display a visual editing interface. The receiving module 960 is configured to receive, on the visual editing interface, an editing operation on at least some key point images in the key point image sequence. The processing module 970 is configured to obtain the edited key point image sequence after performing the editing operation on the key point images. 910-940 in FIGS. 9 and 810-840 in FIG. 8 have the same function and structure.

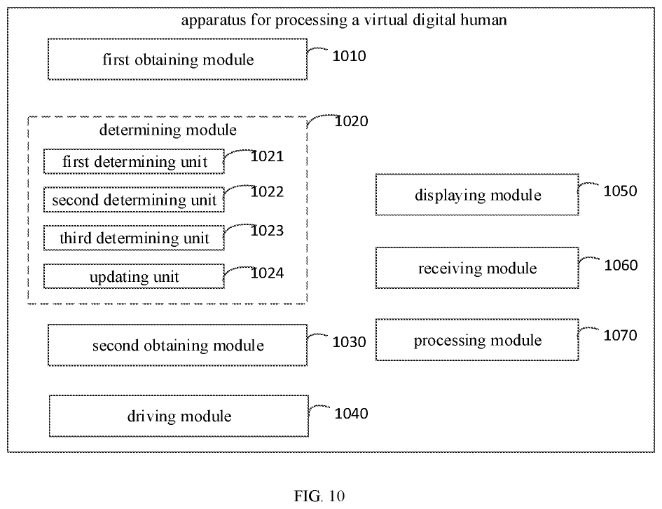

Optionally, in some embodiments of the disclosure, as shown in FIG. 10, the determining module 1020 includes: a first determining unit 1021, a second determining unit 1022, a third determining unit 1023, and an updating unit 1024. The first determining unit 1021 is configured to determine, based on a T-shape pose image in the key point image sequence, a body structure ratio of the reference role in the T-shape pose image. The second determining unit 1022 is configured to determine a body joint ratio of the virtual digital human. The third determining unit 1023 is configured to determine the key point data of the virtual digital human corresponding to the key point data in the key point image sequence based on the key point data in the key point image sequence when the virtual digital human is projected into the two-dimensional space. The updating unit 1024 is configured to update the key point data of the virtual digital human based on the body structure ratio of the reference role and the body joint ratio of the virtual digital human. For example, updated content is respective vector length ratios of connection lines among key points in the key point data of the virtual digital human. 1010-1070 in FIGS. 10 and 910-970 in FIG. 9 have the same function and structure.

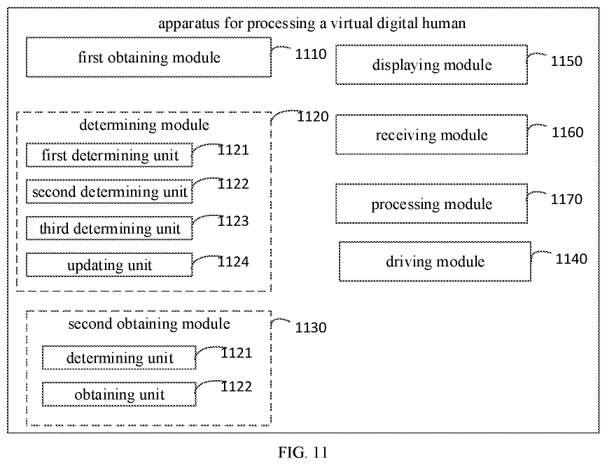

Optionally, in some embodiments of the disclosure, as shown in FIG. 11, the second obtaining module 1130 includes: a determining unit 1131 and an obtaining unit 1132. The determining unit 1131 is configured to determine, based on the key point data of the virtual digital human, an action encoding vector corresponding to the key point data of the virtual digital human. The obtaining unit 1132 is configured to obtain the bone rotation coefficient sequence of the virtual digital human based on the action encoding vector corresponding to the key point data of the virtual digital human. 1110-1170 in FIG. 11 have the same function and structure as 1010-1070 in FIG. 10.

Optionally, in some embodiments of the disclosure, the determining unit 1131 is further configured to: input the key point data of the virtual digital human into a preset virtual digital human creation model; in which the virtual digital human creation model has learned to obtain a mapping relation between the key point data and the bone rotation coefficient sequence, and the virtual digital human creation model includes an action encoding sub-model and an action prior sub-model; and obtain the action encoding vector corresponding to the key point data of the virtual digital human output by the action encoding sub-model. The obtaining unit 1132 is further configured to: input the action encoding vector corresponding to the key point data of the virtual digital human into the action prior sub-model, and obtain the bone rotation coefficient sequence of the virtual digital human.

With respect to the apparatus in the above-described embodiments, the specific manner in which each module performs its operation has been described in detail in the embodiments relating to the method and will not be described in detail herein.

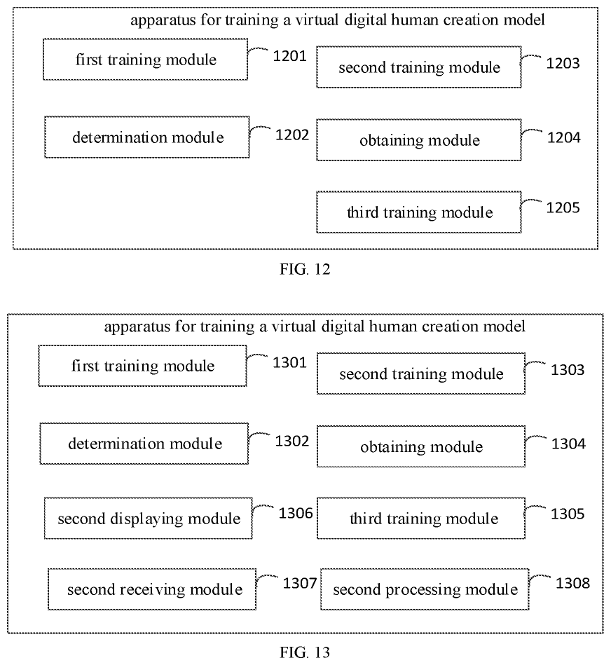

In order to implement the above embodiments, the disclosure further provides an apparatus for training a virtual digital human creation model. The virtual digital human creation model includes an action encoding sub-model and an action prior sub-model. FIG. 12 is a schematic diagram of an apparatus for training a virtual digital human creation model according to some embodiments of the disclosure. As shown in FIG. 12, the apparatus further includes: a first training module 1201, a determination module 1202, a second training module 1203, an obtaining module 1204, and a third training module 1205.

The first training module 1201 is configured to obtain motion capture data and analyze the motion capture data to obtain a first bone rotation coefficient of the virtual digital human, and train a variational auto-encoder based on the first bone rotation coefficient, in which the variational auto-encoder includes an encoder, an intermediate encoding vector, and a decoder.

The determination module 1202 is configured to determine the intermediate encoding vector and the decoder of the trained variational auto-encoder as the action prior sub-model.

The second training module 1203 is configured to train the action prior sub-model based on a key point image sequence of a reference role sample, and determine model parameters of the action prior sub-model until the trained action prior sub-model satisfies preset conditions.

In an implementation, the second training module 1203 is further configured to: obtain the key point data of the virtual digital human based on the key point image sequence and a body joint ratio of the virtual digital human; input the key point data of the virtual digital human into the action prior sub-model, and obtain a first bone rotation coefficient prediction value output by the action prior sub-model; project the first bone rotation coefficient prediction value into a two-dimensional space, to obtain a key point data prediction value of the virtual digital human; generate a first loss value based on the key point data of the virtual digital human and the key point data prediction value; and train the action prior sub-model based on the first loss value.

In a possible implementation, the second training module 1203 is further configured to: determine a body structure ratio of the reference role in a T-shape pose image based on the T-shape pose image in the key point image sequence; determine the body joint ratio of the virtual digital human; determine the key point data of the virtual digital human corresponding to key point data in the key point image sequence in response to projecting the virtual digital human into the two-dimensional space; and update the key point data of the virtual digital human based on the body structure ratio of the reference role and the body joint ratio of the virtual digital human.

The obtaining module 1204 is configured to obtain training data, in which the training data includes key point data of the virtual digital human and a second bone rotation coefficient.

The third training module 1205 is configured to train the virtual digital human creation model based on the key point data of the virtual digital human and the second bone rotation coefficient until training termination conditions are satisfied.

In an implementation, the third training module 1205 is further configured to: input the key point data of the virtual digital human into the action encoding sub-model, and obtain an action encoding vector output by the action encoding sub-model; input the action encoding vector to the action prior sub-model, and obtain a second bone rotation coefficient prediction value output by the action prior sub-model; generate a second loss value based on the second bone rotation coefficient prediction value and the second bone rotation coefficient; and adjust model parameters of the action encoding sub-model based on the second loss value.

Optionally, in some embodiments of the disclosure, as shown in FIG. 13, the apparatus further includes: a second displaying module 1306, a second receiving module 1307, and a second processing module 1308. The second displaying module 1306 is configured to display a visual editing interface. The second receiving module 1307 is configured to receive, on the visual editing interface, an editing operation on at least some key point images in the key point image sequence. The second processing module 1308 is configured to obtain the edited key point image sequence after performing the editing operation on the key point images respectively. 1301-1305 in FIGS. 13 and 1201-1205 in FIG. 12 have the same function and structure.

With respect to the apparatus in the above-described embodiments, the specific manner in which each module performs its operation has been described in detail in the embodiments relating to the method and will not be described in detail herein.

According to the embodiments of the disclosure, the disclosure also provides an electronic device and a readable storage medium.

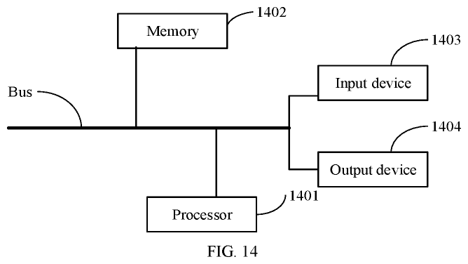

FIG. 14 is a block diagram of an electronic device for implementing a method for processing a virtual digital human or a training method according to some embodiments of the disclosure. Electronic devices are intended to represent various forms of digital computers, such as laptop computers, desktop computers, workbenches, personal digital assistants, servers, blade servers, mainframe computers, and other suitable computers. Electronic devices may also represent various forms of mobile devices, such as personal digital processing, cellular phones, smart phones, wearable devices, and other similar computing devices. The components shown here, their connections and relations, and their functions are merely examples, and are not intended to limit the implementation of the disclosure described and/or required herein.

As illustrated in FIG. 14, the electronic device includes: one or more processors 1401, a memory 1402, and interfaces for connecting various components, including a high-speed interface and a low-speed interface. The various components are interconnected using different buses and can be mounted on a common mainboard or otherwise installed as required. The processor may process instructions executed within the electronic device, including instructions stored in or on the memory to display graphical information of the GUI on an external input/output device such as a display device coupled to the interface. In other embodiments, a plurality of processors and/or buses can be used with a plurality of memories and processors, if desired. Similarly, a plurality of electronic devices can be connected, each providing some of the necessary operations (for example, as a server array, a group of blade servers, or a multiprocessor system). A processor 1401 is taken as an example in FIG. 14.

The memory 1402 is a non-transitory computer-readable storage medium according to the disclosure. The memory stores instructions executable by at least one processor, so that the at least one processor executes the method for processing a virtual digital human or the method for training a virtual digital human creation model according to the disclosure. The non-transitory computer-readable storage medium of the disclosure stores computer instructions, which are used to cause a computer to execute the method for processing a virtual digital human or the method for training a virtual digital human creation model according to the disclosure.

As a non-transitory computer-readable storage medium, the memory 1402 is configured to store non-transitory software programs, non-transitory computer-executable programs and modules, such as program instructions/modules corresponding to any one of the methods according to the embodiments of the disclosure. The processor 1401 executes various functional applications and data processing of the server by running the non-transitory software programs, instructions, and modules stored in the memory 1402, to implement the method for processing a virtual digital human or the method for training a virtual digital human creation model in the above method embodiments.

The memory 1402 may include a storage program area and a storage data area, where the storage program area may store an operating system and application programs required for at least one function. The storage data area may store data created according to the use of the electronic device. In addition, the memory 1402 may include a high-speed random access memory, and a non-transitory memory, such as at least one magnetic disk storage device, a flash memory device, or other non-transitory solid-state storage devices. In some embodiments, the memory 1402 may optionally include a memory remotely disposed with respect to the processor 1401, and these remote memories may be connected to the electronic device through a network. Examples of the above network include, but are not limited to, the Internet, an intranet, a Local Area Network (LAN), a mobile communication network, and combinations thereof.

The electronic device may also include: an input device 1403 and an output device 1404. The processor 1401, the memory 1402, the input device 1403 and the output device 1404 may be connected by a bus or in other ways, and the connection by a bus is taken as an example in FIG. 14.

The input device 1403 may receive inputted numeric or character information, and generate key signal inputs related to user settings and function control of an electronic device, such as a touch screen, a keypad, a mouse, a trackpad, a touchpad, an indication rod, one or more mouse buttons, trackballs, joysticks and other input devices. The output device 1404 may include a display device, an auxiliary lighting device (for example, a Light Emitting Diode (LED)), a haptic feedback device (for example, a vibration motor), and the like. The display device may include, but is not limited to, a Liquid Crystal Display (LCD), a LED display, and a plasma display. In some embodiments, the display device may be a touch screen.

Various embodiments of the systems and technologies described herein may be implemented in digital electronic circuit systems, integrated circuit systems, Application Specific Integrated Circuits (ASICs), computer hardware, firmware, software, and/or combinations thereof. These various embodiments may be implemented in one or more computer programs, which may be executed and/or interpreted on a programmable system including at least one programmable processor. The programmable processor may be a dedicated or general purpose programmable processor that receives data and instructions from a storage system, at least one input device, and at least one output device, and transmits the data and instructions to the storage system, the at least one input device, and the at least one output device.

These computing programs (also known as programs, software, software applications, or code) include machine instructions of a programmable processor and may utilize high-level processes and/or object-oriented programming languages, and/or assembly/machine languages to implement these calculation procedures. As used herein, the terms “machine-readable medium” and “computer-readable medium” refer to any computer program product, device, and/or device used to provide machine instructions and/or data to a programmable processor (for example, magnetic disks, optical disks, memories, Programmable Logic Devices (PLDs), including machine-readable media that receive machine instructions as machine-readable signals. The term “machine-readable signal” refers to any signal used to provide machine instructions and/or data to a programmable processor.

In order to provide interaction with a user, the systems and techniques described herein may be implemented on a computer having a display device (e.g., a Cathode Ray Tube (CRT) or a LCD monitor for displaying information to a user); and a keyboard and pointing device (such as a mouse or trackball) through which the user can provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or tactile input).

The systems and technologies described herein can be implemented in a computing system that includes background components (for example, a data server), or a computing system that includes middleware components (for example, an application server), or a computing system that includes front-end components (for example, a user computer with a graphical user interface or a web browser, through which the user can interact with the implementation of the systems and technologies described herein), or a computing system that includes any combination of such background components, intermediate computing components, or front-end components. The components of the system may be interconnected by any form or medium of digital data communication (e.g., a communication network). Examples of communication networks include: a LAN, a Wide Area Network (WAN), the Internet and a block-chain network.

The computer system may include a client and a server. The client and server are generally remote from each other and interacting through a communication network. The client-server relation is generated by computer programs running on the respective computers and having a client-server relation with each other. The server may be a cloud server, also known as a cloud computing server or a cloud host, which is a host product in the cloud computing service system, to solve the defects of difficult management and weak business scalability in the traditional physical host and Virtual Private Server (VPS) service. The server can also be a server of distributed system or a server combined with block-chain.

It should be understood that the various forms of processes shown above can be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions can be made according to design requirements and other factors. Any modification, equivalent replacement and improvement made within the spirit and principle of the disclosure shall be included in the protection scope of the disclosure.

What is claimed is:

1. A method for processing a virtual digital human, comprising:
obtaining a key point image sequence of a reference role;
determining key point data of the virtual digital human corresponding to key point data in the key point image sequence based on the key point data in the key point image sequence when the virtual digital human is projected into a two-dimensional space;
obtaining a bone rotation coefficient sequence of the virtual digital human based on the key point data of the virtual digital human; and
driving the virtual digital human to perform corresponding actions based on the bone rotation coefficient sequence.

2. The method of claim 1, further comprising:
displaying a visual editing interface;
receiving, on the visual editing interface, an editing operation on at least some key point images in the key point image sequence; and
obtaining the edited key point image sequence after performing the editing operation on the key point images.

3. The method of claim 1, wherein determining the key point data of the virtual digital human corresponding to the key point data in the key point image sequence based on the key point data in the key point image sequence when the virtual digital human is projected into the two-dimensional space, comprises:
determining, based on a T-shape pose image in the key point image sequence, a body structure ratio of the reference role in the T-shape pose image;
determining a body joint ratio of the virtual digital human;
determining the key point data of the virtual digital human corresponding to the key point data in the key point image sequence based on the key point data in the key point image sequence when the virtual digital human is projected into the two-dimensional space; and
updating the key point data of the virtual digital human based on the body structure ratio of the reference role and the body joint ratio of the virtual digital human.

4. The method of claim 3, wherein updated content is respective vector length ratios of connection lines among key points in the key point data of the virtual digital human.

5. The method of claim 1, wherein obtaining the bone rotation coefficient sequence of the virtual digital human based on the key point data of the virtual digital human, comprises:
determining, based on the key point data of the virtual digital human, an action encoding vector corresponding to the key point data of the virtual digital human; and
obtaining the bone rotation coefficient sequence of the virtual digital human based on the action encoding vector corresponding to the key point data of the virtual digital human.

6. The method of claim 5, wherein determining, based on the key point data of the virtual digital human, the action encoding vector corresponding to the key point data of the virtual digital human, comprises:
inputting the key point data of the virtual digital human into a preset virtual digital human creation model; wherein the virtual digital human creation model has learned to obtain a mapping relation between the key point data and the bone rotation coefficient sequence, and the virtual digital human creation model comprises an action encoding sub-model and an action prior sub-model; and
obtaining the action encoding vector corresponding to the key point data of the virtual digital human, output by the action encoding sub-model; wherein
obtaining the bone rotation coefficient sequence of the virtual digital human based on the action encoding vector corresponding to the key point data of the virtual digital human, comprises:
inputting the action encoding vector corresponding to the key point data of the virtual digital human into the action prior sub-model, and obtaining the bone rotation coefficient sequence of the virtual digital human.

7. A method for training a virtual digital human creation model, wherein the virtual digital human creation model comprises an action encoding sub-model and an action prior sub-model, and the method comprises:
obtaining motion capture data and analyzing the motion capture data, to obtain a first bone rotation coefficient of the virtual digital human, and training a variational auto-encoder based on the first bone rotation coefficient, wherein the variational auto-encoder comprises an encoder, an intermediate encoding vector, and a decoder;
determining the intermediate encoding vector and the decoder of the trained variational auto-encoder as the action prior sub-model;
training the action prior sub-model based on a key point image sequence of a reference role sample, and determining model parameters of the action prior sub-model until the trained action prior sub-model satisfies preset conditions;
obtaining training data, wherein the training data comprises key point data of the virtual digital human and a second bone rotation coefficient; and
training the virtual digital human creation model based on the key point data of the virtual digital human and the second bone rotation coefficient until training termination conditions are satisfied.

8. The method of claim 7, wherein training the action prior sub-model based on the key point image sequence of the reference role sample, comprises:
obtaining the key point data of the virtual digital human based on the key point image sequence and a body joint ratio of the virtual digital human;
inputting the key point data of the virtual digital human into the action prior sub-model, and obtaining a first bone rotation coefficient prediction value output by the action prior sub-model;
projecting the first bone rotation coefficient prediction value into a two-dimensional space, to obtain a key point data prediction value of the virtual digital human;
generating a first loss value based on the key point data of the virtual digital human and the key point data prediction value; and
training the action prior sub-model based on the first loss value.

9. The method of claim 8, wherein obtaining the key point data of the virtual digital human based on the key point image sequence and the body joint ratio of the virtual digital human, comprises:
determining a body structure ratio of the reference role in a T-shape pose image based on the T-shape pose image in the key point image sequence;
determining the body joint ratio of the virtual digital human;
determining the key point data of the virtual digital human corresponding to key point data in the key point image sequence in response to projecting the virtual digital human into the two-dimensional space; and
updating the key point data of the virtual digital human based on the body structure ratio of the reference role and the body joint ratio of the virtual digital human.

10. The method of claim 7, wherein training the virtual digital human creation model based on the key point data of the virtual digital human and the second bone rotation coefficient, comprises:
inputting the key point data of the virtual digital human into the action encoding sub-model, and obtaining an action encoding vector output by the action encoding sub-model;
inputting the action encoding vector to the action prior sub-model, and obtaining a second bone rotation coefficient prediction value output by the action prior sub-model;
generating a second loss value based on the second bone rotation coefficient prediction value and the second bone rotation coefficient; and
adjusting model parameters of the action encoding sub-model based on the second loss value.

11. The method of claim 7, further comprising:
displaying a visual editing interface;
receiving, on the visual editing interface, an editing operation on at least some key point images in the key point image sequence; and
obtaining the edited key point image sequence after performing the editing operation on the key point images respectively.

12. An electronic device, comprising:
a processor; and
a memory communicatively coupled to the processor and configured to store instructions executable by the processor; wherein
the processor is configured to execute the instructions to:
obtain a key point image sequence of a reference role;
determine key point data of the virtual digital human corresponding to key point data in the key point image sequence based on the key point data in the key point image sequence when the virtual digital human is projected into a two-dimensional space;
obtain a bone rotation coefficient sequence of the virtual digital human based on the key point data of the virtual digital human; and
drive the virtual digital human to perform corresponding actions based on the bone rotation coefficient sequence.

13. The device of claim 12, wherein the processor is further configured to execute the instructions to:
display a visual editing interface;
receive, on the visual editing interface, an editing operation on at least some key point images in the key point image sequence; and
obtain the edited key point image sequence after performing the editing operation on the key point images.

14. The device of claim 12, wherein the processor is further configured to execute the instructions to:
determine, based on a T-shape pose image in the key point image sequence, a body structure ratio of the reference role in the T-shape pose image;
determine a body joint ratio of the virtual digital human;
determine the key point data of the virtual digital human corresponding to the key point data in the key point image sequence based on the key point data in the key point image sequence when the virtual digital human is projected into the two-dimensional space; and
update the key point data of the virtual digital human based on the body structure ratio of the reference role and the body joint ratio of the virtual digital human.

15. The device of claim 14, wherein updated content is respective vector length ratios of connection lines among key points in the key point data of the virtual digital human.

16. The device of claim 12, wherein the processor is further configured to execute the instructions to:
determine, based on the key point data of the virtual digital human, an action encoding vector corresponding to the key point data of the virtual digital human; and
obtain the bone rotation coefficient sequence of the virtual digital human based on the action encoding vector corresponding to the key point data of the virtual digital human.

17. The device of claim 16, wherein the processor is further configured to execute the instructions to:
input the key point data of the virtual digital human into a preset virtual digital human creation model; wherein the virtual digital human creation model has learned to obtain a mapping relation between the key point data and the bone rotation coefficient sequence, and the virtual digital human creation model comprises an action encoding sub-model and an action prior sub-model; and
obtain the action encoding vector corresponding to the key point data of the virtual digital human, output by the action encoding sub-model; wherein
obtain the bone rotation coefficient sequence of the virtual digital human based on the action encoding vector corresponding to the key point data of the virtual digital human, comprises:
input the action encoding vector corresponding to the key point data of the virtual digital human into the action prior sub-model, and obtaining the bone rotation coefficient sequence of the virtual digital human.

18. An electronic device, comprising:
a processor; and
a memory communicatively coupled to the processor and configured to store instructions executable by the processor; wherein
the processor is configured to execute the instructions to perform the method of claim 7.

19. A non-transitory computer readable storage medium having computer instructions stored thereon, wherein the computer instructions are configured to cause a computer to implement the method of claim 1.

20. A non-transitory computer readable storage medium having computer instructions stored thereon, wherein the computer instructions are configured to cause a computer to implement the method of claim 7.
